(19) United States
(12) Patent Application Publication
(10) Pub. No.: US 2023/0108644 A1
(43) Pub. Date: Apr. 6, 2023

(54) EMBEDDED SUBSCRIBER IDENTITY MODULE BOOTSTRAP BROKER FOR EMBEDDED SUBSCRIBER IDENTITY MODULE BASED SERVICES

(71) Applicant: AT&T Intellectual Property I, L.P., Atlanta, GA (US)

(72) Inventor: Jason Sikes, Carnation, WA (US)

(21) Appl. No.: 17/492,368

(22) Filed: Oct. 1, 2021

(51) Int. Cl. H04W 4/50; H04W 4/24

(52) U.S. Cl. CPC H04W 4/50; H04W 4/24

(57) ABSTRACT

An embedded subscriber identity module (eSIM) bootstrap broker for eSIM based services is presented herein. A system generates and stores different international mobile subscriber identity (IMSI) profiles corresponding to mobile devices to facilitate respective accesses of network services based on the different IMSI profiles, and sends portions(s) of the different IMSI profiles to an eSIM service. The eSIM service generates respective eSIM bootstrap profiles comprising the different IMSI profiles and allocates the respective eSIM bootstrap profiles to respective device manufactures of the mobile devices for storage of the respective eSIM bootstrap profiles in the mobile devices. In response to matching an IMSI profile that has been included in a request for an access of the network services that has been received from a mobile device with a stored IMSI profile of the stored IMSI profiles, the system enables the access for the mobile device.

### TECHNICAL FIELD

The subject disclosure generally relates to embodiments for an embedded subscriber identity module (eSIM) bootstrap broker for eSIM based services.

### BACKGROUND

Bootstrapping, or provisioning of a bootstrap profile in an eSIM of a wireless device, facilitates access, by the wireless device, of wireless service(s) provided via a wireless service provider's network. The bootstrap profile is a unique operational profile enabling limited, or controlled, access related to downloading a wireless device user's operational profile specifying information required for the wireless device to access, connect to, etc. the wireless service provider's network based on a subscription, user plan, policy, etc. corresponding to the wireless service(s).

During bootstrapping, the bootstrap profile is loaded, programmed, etc. into the eSIM by device manufacturers, e.g., using a wired interface, to facilitate access to the wireless service(s). Due to costs and overhead required to manage and load unique bootstrap profiles corresponding to different wireless carriers into eSIMs of corresponding wireless devices, device manufacturers are reluctant to implement bootstrapping of eSIMs. Consequently, bootstrapping technologies have had some drawbacks, some of which are noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a communication environment including an eSIM bootstrap broker system for facilitating improved bootstrapping services, in accordance with various example embodiments;

FIG. 2 illustrates a block diagram of an eSIM bootstrap broker system for facilitating improved bootstrapping services, in accordance with various example embodiments;

FIG. 3 illustrates a block diagram of an IMSI profile component, in accordance with various example embodiments;

FIG. 4 illustrates another block diagram of an eSIM bootstrap broker system, in accordance with various example embodiments;

FIGS. 5-8 illustrate flow charts of a method associated with facilitating improved bootstrapping services, in accordance with various example embodiments;

FIGS. 9-11 illustrate flow charts of another method associated with facilitating improved bootstrapping services, in accordance with various example embodiments; and

FIG. 12 is a block diagram representing an illustrative non-limiting computing system or operating environment in which one or more aspects of various embodiments described herein can be implemented for facilitating improved bootstrapping services, in accordance with various example embodiments.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, conventional bootstrapping technologies have had some drawbacks with respect to costs and overhead required to manage and load unique bootstrap profiles of different wireless carriers into eSIMs of wireless devices. On the other hand, various embodiments disclosed herein can facilitate improved bootstrappping services by enabling a wireless carrier to provide, e.g., based on one-time and/or per-use fee(s) that are allocated to the wireless carrier, bootstrap profiles to an eSIM provider that, in turn, can offer bootstrap services to other wireless carriers, e.g., on a regional or global basis—the eSIM provider acting as a mobile virtual network operator-like broker to the other wireless carriers.

For example, in embodiment(s), a system comprises a processor and a memory that stores executable instructions that, when executed by the processor, facilitate performance of operations by the processor—the operations comprising: generating different international mobile subscriber identity (IMSI) profiles corresponding to respective mobile devices, in which the different IMSI profiles facilitate respective accesses, via the respective mobile devices, of network services enabled via a network associated with a network service provider; storing, as stored IMSI profiles, the different IMSI profiles in data storage devices of the network associated with the network service provider; and sending at least a portion of the different IMSI profiles to an eSIM device corresponding to an eSIM service to facilitate the respective accesses of the network services, e.g., based the on one-time and/or per-use fee(s) that are allocated, e.g., via the eSIM service and/or via wireless carriers corresponding to the respective mobile devices, to the network service provider.

In response to receiving the portion(s) of the different IMSI profiles, the eSIM service generates respective eSIM bootstrap profiles including the portion(s) of the different IMSI profiles, and allocates the respective eSIM bootstrap profiles to respective device manufacturers corresponding to the respective mobile devices—the respective mobile devices being associated with wireless carriers. In turn, the respective device manufacturers store the eSIM bootstrap profiles in the respective mobile devices.

Further, the operations comprise: in response to a request for an access of the respective accesses of the network services enabled via the network being determined to have been received from the mobile device—the request including an IMSI profile that has been stored in the mobile device—and further in response to matching the IMSI profile with a stored IMSI profile of the stored IMSI profiles, enabling, based on the IMSI profile, the access for the mobile device, e.g., based on the one-time or per-use fee(s) that are allocated to the network service provider, e.g., via the eSIM service and/or the wireless carriers corresponding to the respective mobile devices.

In other embodiment(s), a method comprises: generating, by a system comprising a processor, different IMSI profiles corresponding to respective mobile devices, in which accesses, by the respective mobile devices, of network services enabled via a network associated with a network service provider have been authorized, via the network, using the different IMSI profiles; storing, by the system, the different IMSI profiles in data storage devices of the system; and sending, by the system, the different IMSI profiles to a device associated with provision of an eSIM service.

In turn, the eSIM service generates, via provisioning of the eSIM service, respective eSIM bootstrap profiles comprising the different IMSI profiles, and allocates the respective eSIM bootstrap profiles to respective device manufacturers of the respective mobile devices corresponding to wireless carriers—the respective device manufacturers storing the respective eSIM bootstrap profiles in the respective mobile devices.

Further, the method comprises: in response to receiving, by the system, from a mobile device of the respective mobile devices, a request for an access of the accesses of the network services comprising an IMSI profile of the different IMSI profiles that has been stored in an eSIM of the mobile device, authorizing, by the system using the different IMSI profiles that have been stored in the data storage devices, the IMSI profile that has been stored in the eSIM of the mobile device to facilitate the access for the mobile device. Further, in response to the authorizing of the IMSI profile, the method comprises permitting, by the system, the access for the mobile device, e.g., based on the one-time and/or per-use fee(s) that are allocated to the network service provider, e.g., via the eSIM service and/or the wireless carriers corresponding to the respective mobile devices.

In yet other embodiment(s), a non-transitory machine-readable medium, comprises executable instructions that, when executed by a system comprising a processor, facilitate performance of operations, comprising: generating different IMSI profiles to facilitate respective accesses, by respective mobile devices corresponding to the different IMSI profiles, of a network service enabled via a network corresponding to a network service provider; and in response to storing the different IMSI profiles in a group of data storage devices of the system, sending at least a portion of the different IMSI profiles to an eSIM device corresponding to an eSIM service.

In turn, the eSIM service generates respective eSIM bootstrap profiles comprising the portion of the different IMSI profiles, and allocates the respective eSIM bootstrap profiles to respective device manufacturers of the respective mobile devices corresponding to wireless carriers. Further, the respective device manufacturers store the respective eSIM bootstrap profiles in the respective mobile devices.

The operations further comprise: receiving, from a mobile device of the respective mobile devices, a request for an access of the respective accesses of the network service corresponding to the network service provider—the request comprising an IMSI profile of the different IMSI profiles that has been stored in the mobile device; verifying, using information from the group of data storage devices, that the IMSI profile that has been stored in the mobile device matches a stored IMSI profile of the different IMSI profiles that have been stored in the group of data storage devices; and in response to verifying that the IMSI profile that has been stored in the mobile device matches the stored IMSI profile, enabling, using the IMSI profile, the access for the mobile device, e.g., based on the one-time and/or per-use fee(s) that are allocated to the network service provider, e.g., via the eSIM service and/or the wireless carriers corresponding to the respective mobile devices.

Reference throughout this specification to “one embodiment,” “an embodiment,” etc. means that a particular feature, structure, or characteristic described in connection with the embodiment is included in at least one embodiment. Thus, the appearances of the phrase “in one embodiment,” “in an embodiment,” etc. in various places throughout this specification are not necessarily all referring to the same embodiment. Furthermore, the particular features, structures, or characteristics may be combined in any suitable manner in one or more embodiments.

Device manufactures seek to have a common model, or stock-keeping unit (SKU), for all wireless operators. In turn, based on such model, the device manufactures desire to have a common bootstrap solution across carriers on a regional and/or global basis; however, providing such solution to a wireless carrier places the cost of ownership of the bootstrap service on a device manufacturer—resulting in a reluctance of the device manufacturer to absorb such costs and resist implementing bootstrap solutions corresponding to eSIM based technology.

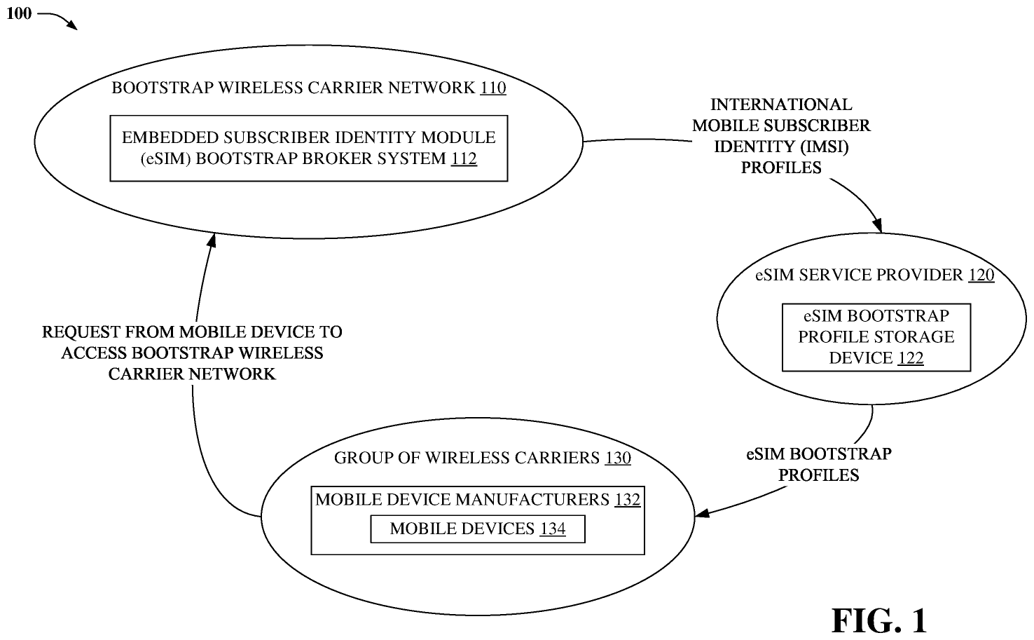

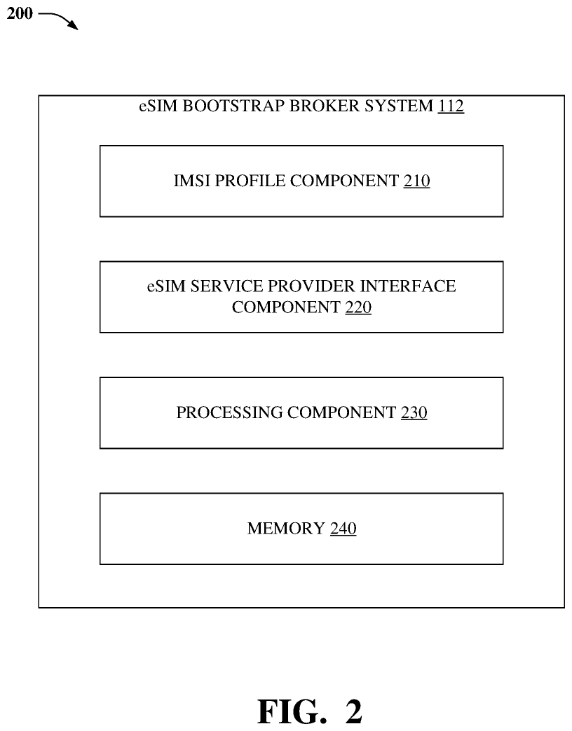

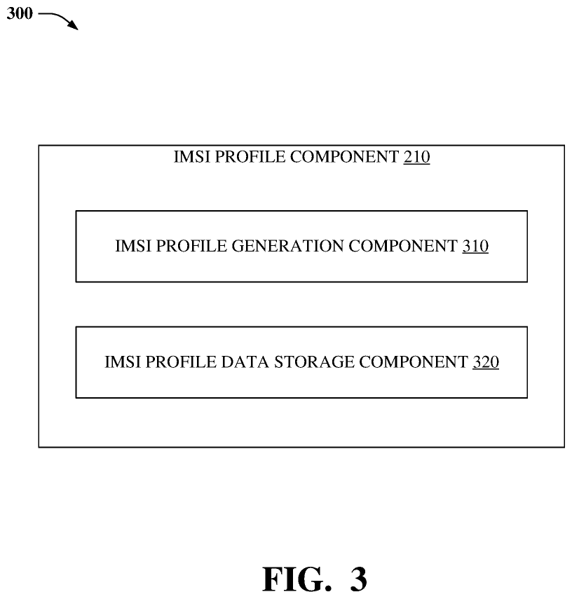

In this regard, and now referring to FIGS. 1-3, in various embodiments described herein an eSIM bootstrap broker system (112) can enable use of bootstrap services on a per-carrier basis by moving the cost burden of such services away from device manufacturers—offering bootstrap services, e.g., as an MVNO-link broker, to wireless carriers, e.g., on a regional or global basis. In turn, the eSIM bootstrap broker system can enable device manufactures to produce common SKUs across the wireless carriers on the regional and/or global basis.

The eSIM bootstrap broker system includes an IMSI profile component (210), an eSIM service provider interface component (220), a processing component (230), and a memory (240). An IMSI is a unique number, e.g. unique IMSI number, which mobile network operators use to recognize a mobile device corresponding to a subscriber, user, etc. of a network associated with a network service provider, or network operator. The IMSI includes a country code, a network operator code representing the network operator, a mobile device number of the mobile device, and a key corresponding to the unique IMSI number that is used to enable the access for the mobile device.

In this regard, the IMSI profile component includes an IMSI profile generation component (320) and an IMSI profile data storage component (320). The IMSI profile generation component generates different IMSI profiles corresponding to respective mobile devices (134)—the different IMSI profiles facilitating respective accesses, via the respective mobile devices, of network services enabled via the network, e.g., bootstrap wireless carrier network (110), associated with the network service provider, e.g., wireless carrier. In turn, the IMSI profile component stores, as stored IMSI profiles via the IMSI profile data storage component, the different IMSI profiles in data storage device(s) of the network associated with the network service provider.

The eSIM service provider interface component sends at least a portion of the different IMSI profiles to an eSIM device (not shown) corresponding to an eSIM service, e.g., corresponding to an eSIM service provider (120) to facilitate the respective accesses of the network services, e.g., based the on one-time and/or per-use fee(s) that are allocated, e.g., via the eSIM service and/or via wireless carriers corresponding to the respective mobile devices, to the network service provider.

In embodiment(s), the eSIM service provider interface component sends the portion(s) of the different IMSI profiles to the eSIM device corresponding to the eSIM service based on agreement data representative of an agreement that has been made between the network service provider and the eSIM service—the agreement enabling the access for the mobile device, e.g., enabling a provision of an eSIM service, based on one or more fees that have paid, via the eSIM service, to a payee identity associated with the network service provider.

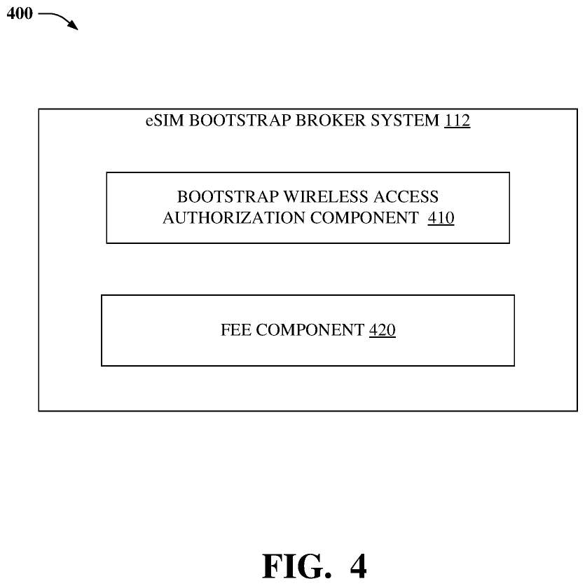

In embodiment(s) illustrated by FIG. 4, the eSIM bootstrap broker system includes a fee component (410) that stores the agreement data representative of the agreement, e.g., specifying fee(s) to be paid to the payee identity associated with the network service provider. In this regard, in an embodiment, the agreement data defines a service charge model that specifies a one-time network access fee that permits the access for the mobile device—the one-time network access fee being payable, via the eSIM service, to the payee identity associated with the network service provider.

In another embodiment, the service charge model further defines a data usage fee that is based on an amount of data that is transferred by the mobile device via the network—the data usage fee being payable, via the eSIM service, to the payee identity associated with the network service provider.

In yet another embodiment, the agreement data defines a license charge model that specifies a one-time licensing fee that permits a defined number of accesses of the respective accesses of the network services for the mobile device—the one-time licensing fee being payable, via the embedded subscriber identity module service, to the payee identity associated with the network service provider.

In response to receiving the portion(s) of the different IMSI profiles from the eSIM service provider interface component, the eSIM service generates respective eSIM bootstrap profiles including the portion(s) of the different IMSI profiles, and stores the respective eSIM bootstrap profiles in an eSIM bootstrap profile storage device (122) to facilitate allocation of the respective eSIM bootstrap profiles to respective device manufacturers (132) corresponding to the respective mobile devices—the respective mobile devices being associated with a group of wireless carriers (130).

In this regard, in response to generating the respective eSIM bootstrap profiles, the eSIM service allocates, e.g., sends, the respective eSIM bootstrap profiles to the respective device manufacturers corresponding to the respective mobile devices. Further, the respective device manufacturers store the eSIM bootstrap profiles in the respective mobile devices.

In embodiment(s) the respective eSIM bootstrap profiles associated with the respective device manufacturers are stored in embedded universal integrated circuit devices of the respective mobile devices, e.g., the embedded universal integrated circuit devices being discrete devices and/or components within the respective mobile devices. In this regard, embedded universal integrated circuit devices can include and/or refer to a universal integrated circuit card (UICC), a removable UICC, an embedded UICC, an integrated UICC, or other means of securing a bootstrap and/or operational profile in a mobile device.

In other embodiment(s), the network is a first network and the network service provider is a first network carrier. Further, the eSIM service allocates an eSIM bootstrap profile of the respective eSIM bootstrap profiles to a second network carrier, different from the first network carrier, corresponding to a device manufacturer of the respective device manufacturers based on agreement data representative of an agreement between the eSIM service and the second network carrier.

In this regard, the agreement data enables the access for the mobile device based on a fee that has been paid, via a second network associated with the second network carrier, to the eSIM service. In embodiment(s), the agreement data defines a service charge model that specifies a one-time network access fee that permits the access for the mobile device—the one-time network access fee being paid, via the second network associated with the second network carrier, to the eSIM service.

In other embodiment(s), the service charge model further defines a data usage fee that is based on an amount of data that has been transferred by the mobile device via the first network—the data usage fee being paid, via the second network associated with the second network carrier, to the eSIM service.

In yet other embodiment(s), the agreement data defines a license charge model that specifies a one-time licensing fee that permits a defined number of accesses of the respective accesses of the network services for the mobile device—the one-time licensing fee being paid, via the second network associated with the second network carrier, to the eSIM service.

Referring again to FIG. 4, the eSIM bootstrap broker system includes a bootstrap wireless access authorization component (420) that receives, from the respective mobile devices, requests for the respective accesses of the network services enabled via the network, e.g., the bootstrap wireless carrier network. In this regard, in response to a request, including an IMSI profile of the different IMSI profiles that has been stored in the mobile device, for an access of the respective accesses of the network services enabled via the network being determined, by the bootstrap wireless access authorization component, to have been received from a mobile device of the respective mobile devices, and further in response to matching, by the bootstrap wireless access authorization component using the data storage devices, the IMSI profile with a stored IMSI profile of the stored IMSI profiles, enabling, based on the IMSI profile, the access for the mobile device.

In an embodiment(s), the network service provider is a first network service provider, the network comprises a visited network, and the bootstrap wireless access authorization component enables a visited access of the visited network for the mobile device based on agreement data representative of an agreement between the first network service provider and a mobile virtual network operator comprising a second network service provider that does not operate the visited network—the agreement data enabling the visited access of the network based on a fee that is payable, via the mobile virtual network operator, to a payee identity associated with the first network service provider.

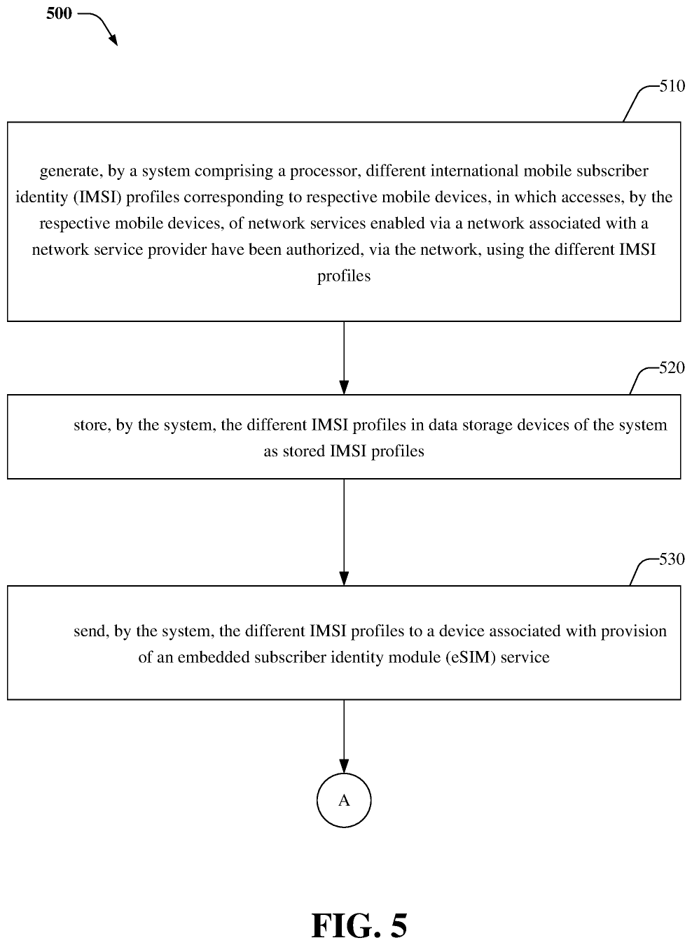

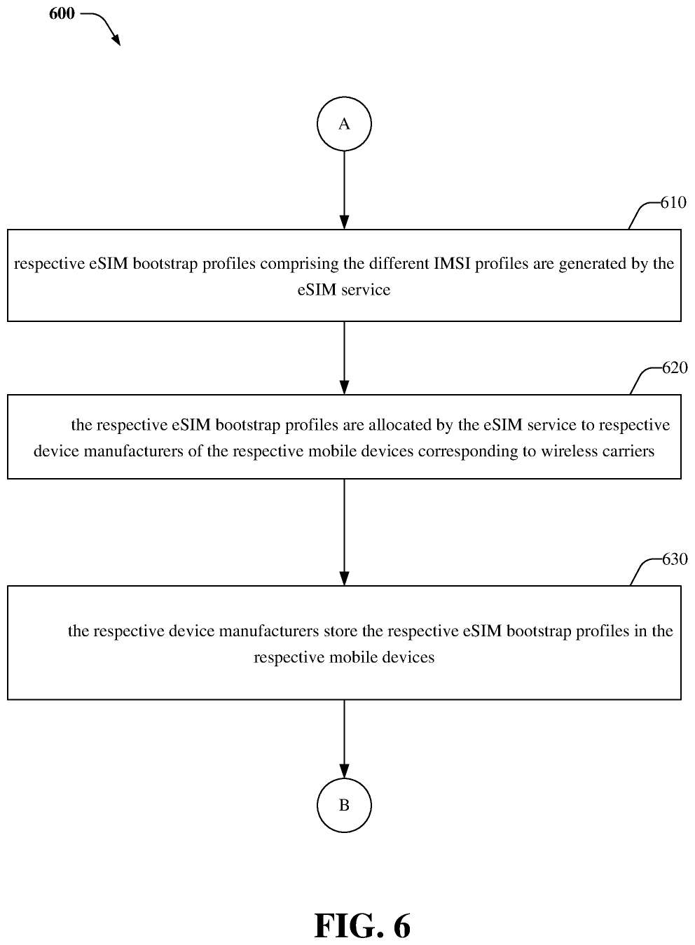

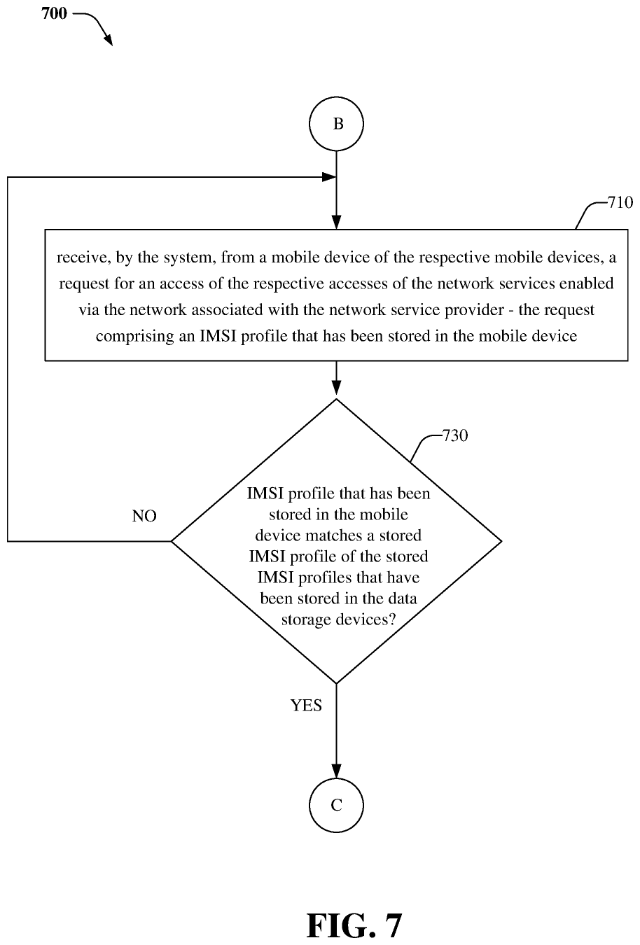

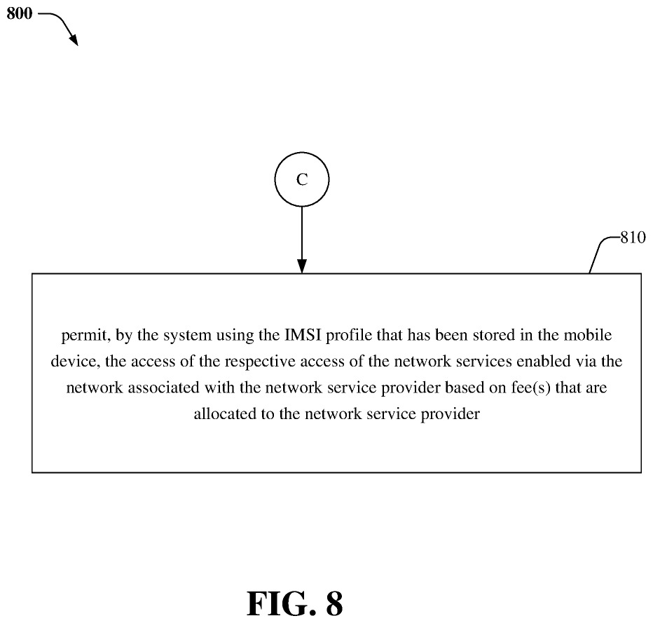

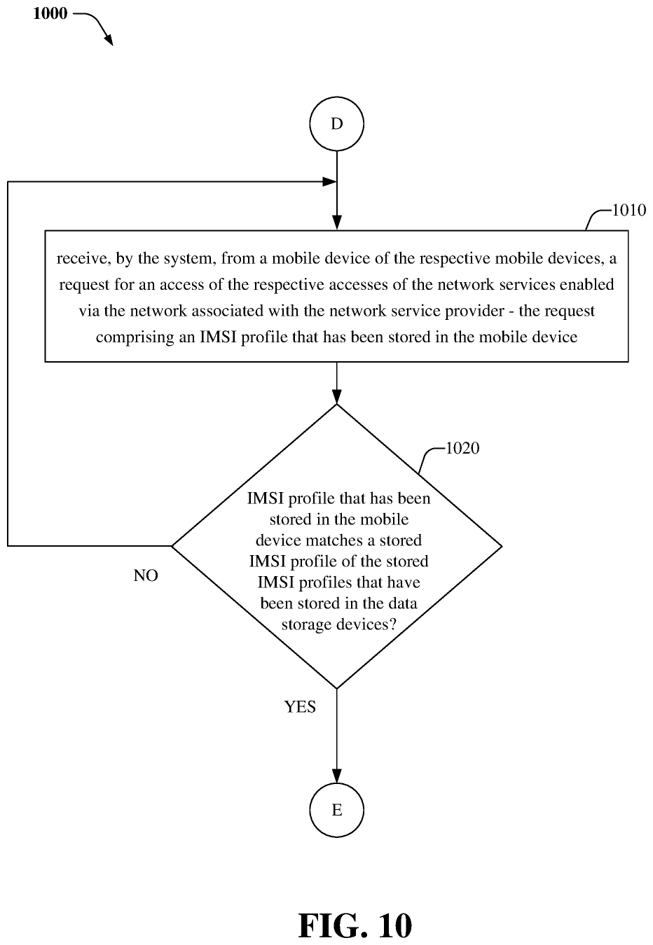

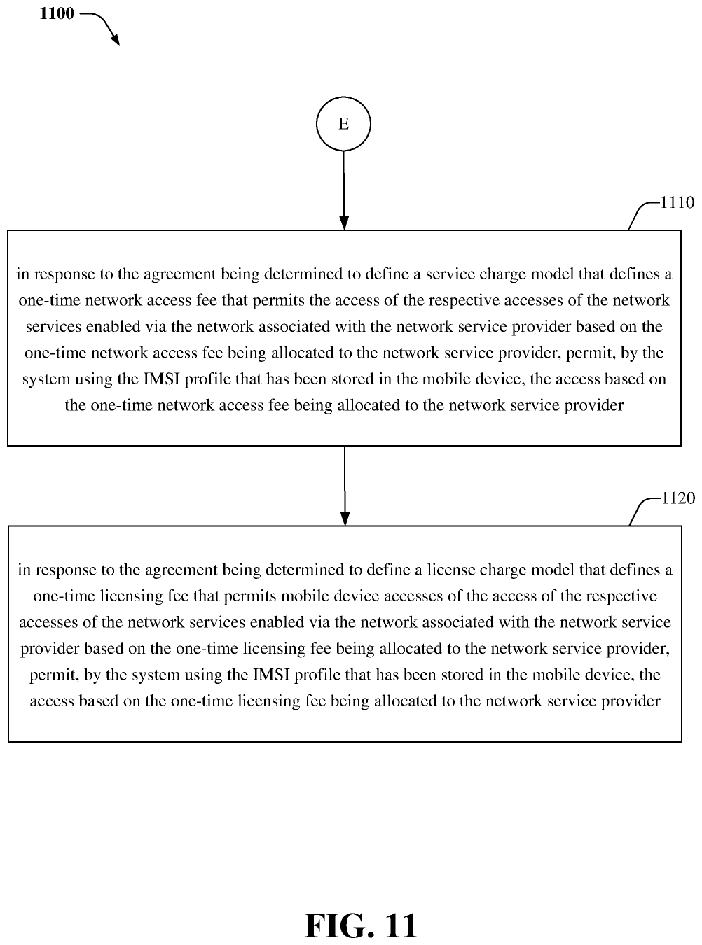

FIGS. 5-11 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIGS. 5-8, flow charts (500-800) of a method associated with facilitating improved bootstrapping services are illustrated, in accordance with various example embodiments. At 510, system (e.g., 112) generates different IMSI profiles corresponding to respective mobile devices, in which accesses, by the respective mobile devices, of network services enabled via a network associated with a network service provider have been authorized, via the network, using the different IMSI profiles.

At 520, the system stores the different IMSI profiles in data storage devices of the system as stored IMSI profiles. At 530, the system sends the different IMSI profiles to a device associated with provision of an eSIM service. At 610, respective eSIM bootstrap profiles comprising the different IMSI profiles are generated by the eSIM service; and at 620, the respective eSIM bootstrap profiles are allocated by the eSIM service to respective device manufacturers of the respective mobile devices corresponding to wireless carriers. In turn, at 630, the respective device manufacturers store the respective eSIM bootstrap profiles in the respective mobile devices.

At 710, the system receives, from a mobile device of the respective mobile devices, a request for an access of the respective accesses of the network service corresponding to the network service provider—the request comprising an IMSI profile that has been stored in the mobile device.

At 730, the system determines whether an IMSI profile that has been stored in the mobile device matches a stored IMSI profile of the stored IMSI profiles that have been stored in the data storage devices of the system. In this regard, in response to the IMSI profile being determined to match the stored IMSI profile, flow continues to 810, at which the system permits, using the IMSI profile that has been stored in the mobile device, the access of the respective access of the network services enabled via the network associated with the network service provider based on fee(s) that are allocated to the network service provider; otherwise flow returns to 710.

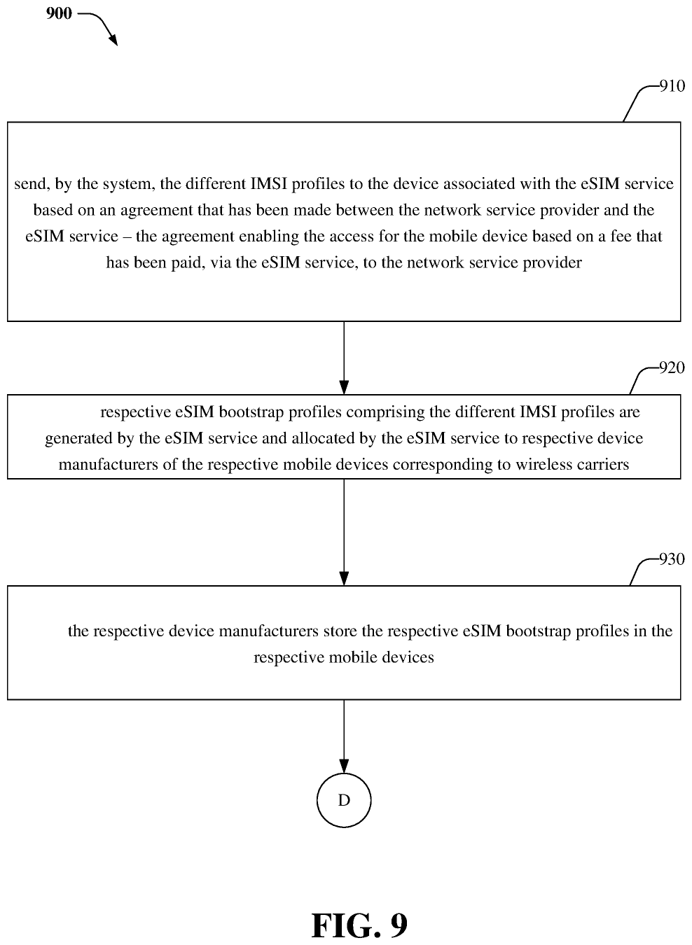

FIGS. 9-11 illustrate flow charts (900-1000) of another method associated with facilitating improved bootstrapping services, in accordance with various example embodiments. At 910, the system (e.g., 112) sends the different IMSI profiles to the device associated with the eSIM service based on an agreement that has been made between the network service provider and the eSIM service—the agreement enabling the access for the mobile device based on a fee that has been paid, via the eSIM service, to the network service provider

At 920, the eSIM service generates respective eSIM bootstrap profiles comprising the different IMSI profiles, and allocates the respective eSIM bootstrap profiles to respective device manufacturers of the respective mobile devices corresponding to wireless carriers. In turn, at 930, the respective device manufacturers store the respective eSIM bootstrap profiles in the respective mobile devices.

At 1010, the system receives, from a mobile device of the respective mobile devices, a request for an access of the respective accesses of the network services enabled via the network associated with the network service provider—the request comprising an IMSI profile that has been stored in the mobile device.

At 1020, the system determines whether an IMSI profile that has been stored in the mobile device matches a stored IMSI profile of the stored IMSI profiles that have been stored in the data storage devices of the system. In this regard, in response to the IMSI profile being determined to match the stored IMSI profile, flow continues to 1110, at which in response to the agreement being determined to define a service charge model that defines a one-time network access fee that permits the access of the respective accesses of the network services enabled via the network associated with the network service provider based on the one-time network access fee being allocated to the network service provider, the system permits, using the IMSI profile that has been stored in the mobile device, the access based on the one-time network access fee being allocated to the network service provider.

At 1120, in response to the agreement being determined to define a license charge model that defines a one-time licensing fee that permits mobile device accesses of the respective accesses of the network services enabled via the network associated with the network service provider based on the one-time licensing fee being allocated to the network service provider, the system permits, using the IMSI profile that has been stored in the mobile device, the access based on the one-time licensing fee being allocated to the network service provider.

As it employed in the subject specification, the term “processor”, “processing component”, or other terms referencing a processing device can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “memory component”, “memory”, “memory storage”, “system memory”, “data storage”, “storage device”, and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in eSIM bootstrap profile storage device 122, memory 240, IMSI profile data storage component 320, system memory 1206 (see below), external storage 1216 (see below), and/or memory storage 1252 (see below). Further, nonvolatile memory can be included in read only memory (ROM), programmable ROM (PROM), electrically programmable ROM (EPROM), electrically erasable ROM (EEPROM), or flash memory. Volatile memory (e.g., 1212) can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

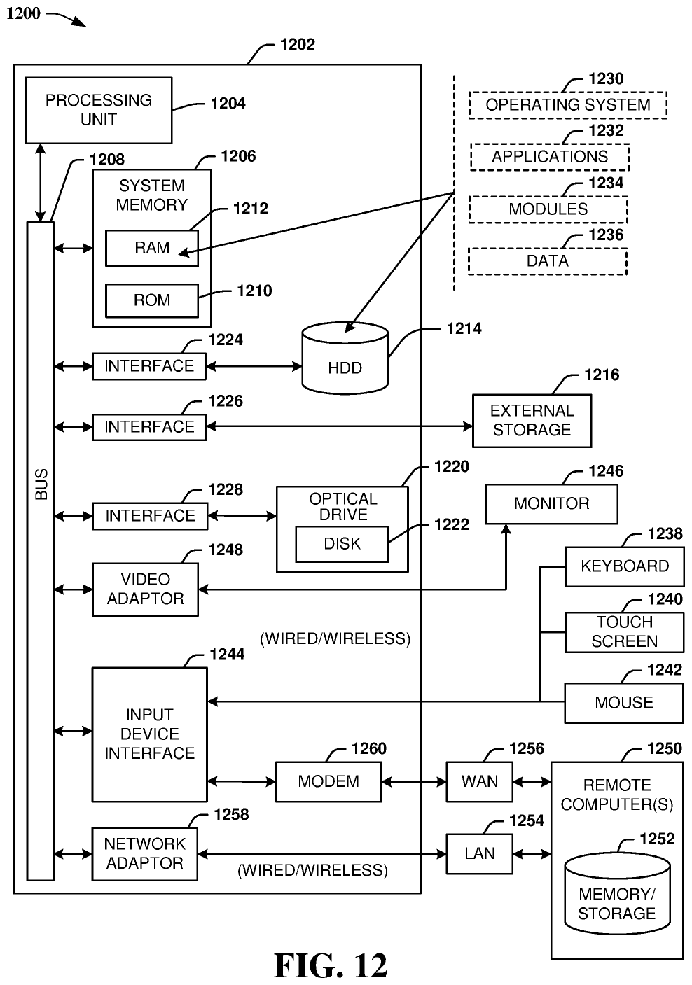

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that in various embodiments, methods disclosed herein can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

As utilized herein, terms “component,” “system,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Further, aspects, features, and/or advantages of the disclosed subject matter can be exploited in substantially any wireless telecommunication or radio technology, e.g., IEEE 802.XX technology, e.g., Wi-Fi, Bluetooth, etc.; WiMAX; enhanced GPRS; 3GPP LTE; 3GPP2; UMB; 3GPP UMTS; HSPA; high speed downlink packet access (HSDPA); high speed uplink packet access (HSUPA); LTE-A, GSM, NFC, Wibree, Zigbee, satellite, Wi-Fi Direct, etc.

Further, selections of a radio technology, or radio access technology, can include second generation (2G), third generation (3G), fourth generation (4G), fifth generation (5G), x^{th} generation, etc. evolution of the radio access technology; however, such selections are not intended as a limitation of the disclosed subject matter and related aspects thereof. Further, aspects, features, and/or advantages of the disclosed subject matter can be exploited in disparate electromagnetic frequency bands. Moreover, one or more embodiments described herein can be executed in one or more network elements, and/or within one or more elements of a network infrastructure, e.g., radio network controller, wireless access point (AP), etc.

Moreover, terms like “mobile device,” “user equipment,” (UE) “mobile station,” “mobile subscriber station,” “access terminal,” “terminal”, “handset,” “appliance,” “machine,” “wireless communication device,” “cellular phone,” “personal digital assistant,” “smartphone,” “wireless device”, and similar terminology refer to a wireless device, or wireless communication device, which is at least one of (1) utilized by a subscriber of a wireless service, or communication service, to receive and/or convey data associated with voice, video, sound, and/or substantially any data-stream or signaling-stream; or (2) utilized by a subscriber of a voice over IP (VoIP) service that delivers voice communications over IP networks such as the Internet or other packet-switched networks. Further, the foregoing terms are utilized interchangeably in the subject specification and related drawings.

A communication environment, e.g., 100, for systems, methods, and/or apparatus disclosed herein can include any suitable mobile and/or wireline-based circuit-switched communication network including a GSM network, a time division multiple access (TDMA) network, a code division multiple access (CDMA) network, such as an Interim Standard 95 (IS-95) and subsequent iterations of CDMA technology, an integrated digital enhanced network (iDEN) network and a PSTN. Further, examples of the communication network can include any suitable data packet-switched or combination data packet/circuit-switched communication network, wired or wireless IP network such as a VoLTE network, a VoIP network, an IP data network, a UMTS network, a GPRS network, or other communication networks that provide streaming data communication over IP and/or integrated voice and data communication over combination data packet/circuit-switched technologies.

Similarly, one of ordinary skill in the art will appreciate that a wireless device, e.g., a wireless communication device, a user equipment, etc. for systems, methods, and/or apparatus disclosed herein can include a mobile device, a mobile phone, a 4G, a 5G, etc. cellular communication device, a PSTN phone, a cellular communication device, a cellular phone, a satellite communication device, a satellite phone, a VoIP phone, WiFi phone, a dual-mode cellular/WiFi phone, a combination cellular/VoIP/WiFi/WiMAX phone, a portable computer, or any suitable combination thereof. Specific examples of a wireless system can include, but are not limited to, a cellular device, such as a GSM, TDMA, CDMA, IS-95 and/or iDEN phone, a cellular/WiFi device, such as a dual-mode GSM, TDMA, IS-95 and/or iDEN/VoIP phones, UMTS phones, UMTS VoIP phones, or like devices or combinations thereof.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

In accordance with various aspects of the subject specification, artificial intelligence based systems, components, etc. can employ classifier(s) that are explicitly trained, e.g., via a generic training data, as well as implicitly trained, e.g., via observing characteristics of communication equipment, e.g., a gateway, a wireless communication device, etc., by receiving reports from such communication equipment, by receiving operator preferences, by receiving historical information, by receiving extrinsic information, etc.

For example, support vector machines can be configured via a learning or training phase within a classifier constructor and feature selection module, component, etc. Thus, the classifier(s) can be used by an artificial intelligence system to automatically learn and perform a number of functions, e.g., performed by a system (e.g., 112), including, but not limited to, authorizing, using different IMSI profiles via data storage devices of the system, an IMSI profile that has been stored in an eSIM of a mobile device to facilitate an access of network services for the mobile device as disclosed herein.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user, e.g., subscriber, desires to be automatically performed. In the case of communication systems, for example, attributes can be information received from access points, services, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., a decision tree based learning model, a linear regression based learning model, support vector machines, neural networks, expert systems, Bayesian belief networks, fuzzy logic, and data fusion engines) can be employed in connection with performing automatic and/or inferred action in connection with the disclosed subject matter.

Further, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable instructions that, when executed by the processor, facilitate performance of operations by the processor, comprising:
generating different international mobile subscriber identity profiles corresponding to respective mobile devices, wherein the different international mobile subscriber identity profiles facilitate respective accesses, via the respective mobile devices, of network services enabled via a network associated with a network service provider;
storing, as stored international mobile subscriber identity profiles, the different international mobile subscriber identity profiles in data storage devices of the network associated with the network service provider;
sending at least a portion of the different international mobile subscriber identity profiles to an embedded subscriber identity module device corresponding to an embedded subscriber identity module service; and
in response to a request for an access of the respective accesses of the network services enabled via the network being determined to have been received from a mobile device of the respective mobile devices, the request comprising an international mobile subscriber identity profile of the different international mobile subscriber identity profiles that has been stored in the mobile device, and further in response to matching, using the data storage devices, the international mobile subscriber identity profile with a stored international mobile subscriber identity profile of the stored international mobile subscriber identity profiles, enabling, based on the international mobile subscriber identity profile, the access for the mobile device, wherein respective embedded subscriber identity module bootstrap profiles comprising at least the portion of the different international mobile subscriber identity profiles have been generated using the embedded subscriber identity module service, wherein an allocation of the respective embedded subscriber identity module bootstrap profiles has been made, using the embedded subscriber identity module service, to respective device manufacturers corresponding to the respective mobile devices, and wherein the respective embedded subscriber identity module bootstrap profiles have been stored, based on the allocation to the respective device manufacturers, in the respective mobile devices.

2. The system of claim 1, wherein the respective embedded subscriber identity module bootstrap profiles associated with the respective device manufacturers are stored in embedded universal integrated circuit devices of the respective mobile devices.

3. The system of claim 1, wherein the international mobile subscriber identity profile comprises a unique international mobile subscriber identity number and a key corresponding to the unique international mobile subscriber identity number that is used to enable the access for the mobile device.

4. The system of claim 1, wherein sending the portion of the different international mobile subscriber identity profiles comprises sending the international mobile subscriber identity profile to the embedded subscriber identity module device corresponding to the embedded subscriber identity module service based on agreement data representative of an agreement between the network service provider and the embedded subscriber identity module service, and wherein the agreement data enables the access for the mobile device based on a fee that has been paid, via the embedded subscriber identity module service, to a payee identity associated with the network service provider.

5. The system of claim 4, wherein the agreement data defines a service charge model that specifies a one-time network access fee that permits the access for the mobile device, and wherein the one-time network access fee is payable, via the embedded subscriber identity module service, to the payee identity associated with the network service provider.

6. The system of claim 5, wherein the service charge model further defines a data usage fee that is based on an amount of data that is transferred by the mobile device via the network, and wherein the data usage fee is payable, via the embedded subscriber identity module service, to the payee identity associated with the network service provider.

7. The system of claim 4, wherein the agreement data defines a license charge model that specifies a one-time licensing fee that permits a defined number of accesses of the respective accesses of the network services for the mobile device, and wherein the one-time licensing fee is payable, via the embedded subscriber identity module service, to the payee identity associated with the network service provider.

8. The system of claim 1, wherein the network is a first network, wherein the network service provider is a first network carrier, wherein an embedded subscriber identity module bootstrap profile of the respective embedded subscriber identity module bootstrap profiles has been allocated, via the embedded subscriber identity module service, to a second network carrier corresponding to a device manufacturer of the respective device manufacturers based on agreement data representative of an agreement between the embedded subscriber identity module service and the second network carrier, wherein the agreement data enables the access for the mobile device based on a fee that has been paid, via a second network associated with the second network carrier, to the embedded subscriber identity module service, and wherein the second network carrier is different from the first network carrier.

9. The system of claim 8, wherein the agreement data defines a service charge model that specifies a one-time network access fee that permits the access for the mobile device, and wherein the one-time network access fee has been paid, via the second network associated with the second network carrier, to the embedded subscriber identity module service.

10. The system of claim 9, wherein the service charge model further defines a data usage fee that is based on an amount of data that has been transferred by the mobile device via the first network, and wherein the data usage fee has been paid, via the second network associated with the second network carrier, to the embedded subscriber identity module service.

11. The system of claim 8, wherein the agreement data defines a license charge model that specifies a one-time licensing fee that permits a defined number of accesses of the respective accesses of the network services for the mobile device, and wherein the one-time licensing fee has been paid, via the second network associated with the second network carrier, to the embedded subscriber identity module service.

12. The system of claim 1, wherein the network service provider is a first network service provider, and wherein the operations further comprise:
receiving the request from the mobile device, wherein the network comprises a visited network, wherein enabling a visited access of the visited network for the mobile device is based on agreement data representative of an agreement between the first network service provider and a mobile virtual network operator comprising a second network service provider that does not operate the visited network, and wherein the agreement data enables the visited access of the network based on a fee that is payable, via the mobile virtual network operator, to a payee identity associated with the first network service provider.

13. A method, comprising:
generating, by a system comprising a processor, different international mobile subscriber identity profiles corresponding to respective mobile devices, wherein accesses, by the respective mobile devices, of network services enabled via a network associated with a network service provider have been authorized, via the network, using the different international mobile subscriber identity profiles;
storing, by the system, the different international mobile subscriber identity profiles in data storage devices of the system;
sending, by the system, the different international mobile subscriber identity profiles to a device associated with provision of an embedded subscriber identity module service; and
in response to receiving, by the system, from a mobile device of the respective mobile devices, a request for an access of the accesses of the network services comprising an international mobile subscriber identity profile of the different international mobile subscriber identity profiles that has been stored in an embedded subscriber identity module of the mobile device,
authorizing, by the system using the different international mobile subscriber identity profiles via the data storage devices, the international mobile subscriber identity profile that has been stored in the embedded subscriber identity module of the mobile device to facilitate the access for the mobile device, and
in response to authorizing the international mobile subscriber identity profile, permitting, by the system, the access for the mobile device, wherein respective embedded subscriber identity module bootstrap profiles comprising the different international mobile subscriber identity profiles have been generated via the embedded subscriber identity module service, wherein the embedded subscriber identity module service has allocated the respective embedded subscriber identity module bootstrap profiles comprising the different international mobile subscriber identity profiles to respective device manufacturers of the respective mobile devices, and wherein the respective device manufacturers have stored the respective embedded subscriber identity module bootstrap profiles in the respective mobile devices.

14. The method of claim 13, wherein sending the different international mobile subscriber identity profiles comprises:
sending the different international mobile subscriber identity profiles to the device associated with the embedded subscriber identity module service based on an agreement that has been made between the network service provider and the embedded subscriber identity module service, and wherein the agreement enables the access for the mobile device based on a fee that has been paid, via the embedded subscriber identity module service, to the network service provider.

15. The method of claim 14, wherein the agreement defines a service charge model that defines a one-time network access fee that permits the access for the mobile device, and wherein the one-time network access fee has been paid, via the embedded subscriber identity module service, to the network service provider.

16. The method of claim 15, wherein the service charge model further defines a data usage fee that is based on an amount of data that is transferred by the mobile device via the network, and wherein the data usage fee has been paid, via the embedded subscriber identity module service, to the network service provider.

17. The method of claim 14, wherein the agreement defines a license charge model that defines a one-time licensing fee that permits mobile device accesses of the accesses of the network services for the mobile device, and wherein the one-time licensing fee has been paid, via the embedded subscriber identity module service, to the network service provider.

18. The method of claim 13, wherein the network service provider is a first network service provider, wherein an embedded subscriber identity module bootstrap profile of the respective embedded subscriber identity module bootstrap profiles has been allocated, via the embedded subscriber identity module service, to a second network service provider based on an agreement that has been made between the embedded subscriber identity module service and the second network service provider, wherein the agreement enables the access for the mobile device based on a fee that has been paid, via the second network service provider, to the embedded subscriber identity module service, and wherein the second network service provider is different from the first network service provider and is associated with a device manufacturer of the respective device manufacturers.

19. A non-transitory machine-readable medium, comprising executable instructions that, when executed by a system comprising a processor, facilitate performance of operations, comprising:
generating different international mobile subscriber identity profiles to facilitate respective accesses, by respective mobile devices corresponding to the different international mobile subscriber identity profiles, of a network service enabled via a network corresponding to a network service provider;
in response to storing the different international mobile subscriber identity profiles in a group of data storage devices of the system, sending at least a portion of the different international mobile subscriber identity profiles to an embedded subscriber identity module device corresponding to an embedded subscriber identity module service;
receiving, from a mobile device of the respective mobile devices, a request for an access of the respective accesses of the network service corresponding to the network service provider, wherein the request comprises an international mobile subscriber identity profile of the different international mobile subscriber identity profiles that has been stored in the mobile device;
verifying, using information from the group of data storage devices, that the international mobile subscriber identity profile that has been stored in the mobile device matches a stored international mobile subscriber identity profile of the different international mobile subscriber identity profiles that have been stored in the group of data storage devices; and
in response to verifying that the international mobile subscriber identity profile that has been stored in the mobile device matches the stored international mobile subscriber identity profile, enabling, using the international mobile subscriber identity profile, the access for the mobile device, wherein respective embedded subscriber identity module bootstrap profiles comprising the portion of the different international mobile subscriber identity profiles have been generated via the embedded subscriber identity module service, wherein the embedded subscriber identity module service has allocated the respective embedded subscriber identity module bootstrap profiles to respective device manufacturers of the respective mobile devices, and wherein the respective device manufacturers have stored the respective embedded subscriber identity module bootstrap profiles in the respective mobile devices.

20. The non-transitory machine-readable medium of claim 19, wherein the network is a first network, wherein the network service provider is a first network service provider, wherein an embedded subscriber identity module bootstrap profile of the respective embedded subscriber identity module bootstrap profiles has been allocated, via the embedded subscriber identity module service, to a second network service provider based on agreement information representative of an agreement defined between the embedded subscriber identity module service and the second network service provider, wherein the agreement data enables the access for the mobile device based on a fee that has been paid, via a second network corresponding to the second network service provider, to the embedded subscriber identity module service, and wherein the second network service provider is different from the first network service provider and is associated with a device manufacturer of the respective device manufacturers.
